(19) United States
(12) Patent Application Publication
(10) Pub. No.: US 2019/0113059 A1
(43) Pub. Date: Apr. 18, 2019

(54) SAFE AND ANTI-LOOSE QUICK-RELEASE ASSEMBLY

(71) Applicant: SHANG HUA LAI, TAICHUNG CITY (TW)

(72) Inventor: SHANG HUA LAI, TAICHUNG CITY (TW)

(21) Appl. No.: 16/033,386

(22) Filed: Jul. 12, 2018

(30) Foreign Application Priority Data
Oct. 13, 2017 (TW) 106135083
Mar. 16, 2018 (TW) 107203467

(51) Int. Cl. F16B 2/18; B60B 27/02

(52) U.S. Cl. CPC F16B 2/185; B60B 2900/3312; B60B 27/026

(57) ABSTRACT

A safe and anti-loose quick-release assembly includes a lever having body which has a cam-shaped portion and a pin is located in the cam-shaped portion. A rod is connected to the pin and extends through a tube. The cam-shaped portion is pivotably engaged with the seat on one end of the tube. The body has a bore defined through the wall thereof, and the pin has a room defined radially therein. A positioning unit is located in the bore and the room. The positioning unit includes a push piece, a biasing piece and a resilient member which is mounted to the biasing piece and biased between a head of the biasing piece and the inner end of the room. The push piece contacts the head of the biasing piece and movably extends beyond the bore. An end part is connected to the distal end of the rod.

### BACKGROUND OF THE INVENTION

### 1. Fields of the Invention

The present invention relates to a quick-release assembly, and more particularly, to a safe and anti-loose quick-release assembly quick-release assembly with an anti-loose device.

### 2. Descriptions of Related Art

The conventional quick-release assembly 9 for bicycles known to application is disclosed in FIG. 10, and includes rod 91 extending though the hub 8 of a bicycle, wherein the first end of the rod 91 extends through a seat 94 on the first end of the rod 91, and a nut 92 is connected to the second end of the rod 91. A lever 93 is pivotably connected to the first end of the rod 91. Specifically, the first end of the rod 91 is connected with a pin which is located in the lever 93. The pin is located at a cam shaped portion of the lever 93. When the user pivots the lever 93, the cam-shaped portion is moved so that the rod 91 moves to secure the front fork 7 and the hub 8.

However, the nut 92 is easily get lost, and once the nut 92 is lost, the whole quick-release assembly has to be replaced with a new one. Besides, the lever 93 can be unexpectedly pivoted to cause dangerous results to the riders.

The present invention is intended to provide a safe and anti-loose quick-release assembly that is designed to eliminate the drawbacks mentioned above.

### SUMMARY OF THE INVENTION

The present invention relates to a safe and anti-loose quick-release assembly and comprises a lever having a body with a cam-shaped portion and a pin is located in the cam-shaped portion. A rod has the first end thereof connected to the pin. The body has a bore defined through the wall thereof, and the pin has a room defined radially therein. A positioning unit is located in the bore and the room, wherein the positioning unit includes a push piece, a biasing piece and a resilient member. The push piece has an end extending beyond the bore. The biasing piece has a head and a shank, and the resilient member is mounted to the shank and biased between the head and the inner end of the room. The push piece contacts the head of the biasing piece. When the push piece protrudes beyond the bore, the lever cannot be pivoted. An end part is connected to the second end of the rod.

Preferably, the rod movably extends through a tube and the tube includes a seat connected to the first end thereof. Multiple holes are defined through the wall of the second end of the tube. A sleeve is mounted to the rod. Multiple plugs are mounted to the sleeve and each plug has a portion movably engaged with the hole corresponding thereto. Each plug has an inclined face defined in the underside of one end thereof. A cone-shaped portion is formed on the end part and inserted into the second end of the tube. The cone-shaped portion is engaged with the inclined face of each of the plugs. When the lever is pivoted and the cam-shape portion securely contacts against the seat, the rod and the cone-shaped portion are moved in Y-axis direction and toward the seat, the portions of the plugs move in X-axis direction to protrude beyond the holes respectively.

Preferably, a spring is mounted to the rod and biased between the seat and the sleeve.

Preferably, each of the plugs is an L-shaped plug.

Preferably, the sleeve includes multiple recesses defined axially in the outer periphery thereof. The plugs are movably located in the recesses.

Preferably, a resilient collar is mounted to the plugs to restrict the plugs from disengaging from the recesses of the sleeve.

Preferably, the cone-shaped portion of the end part includes multiple grooves defined axially in the outer periphery thereof. The plugs are movably located in the grooves. When the end part moves, the plugs are movable along the grooves.

The advantages of the present invention are that the positioning unit effectively prevents the lever from being unexpectedly pivoted. The plugs protrude beyond the holes of the tube when the cone-shaped portion of the end part moves toward the seat by pivoting the lever, such that the quick-release assembly is distinguished of its locked status.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the safe and anti-loose quick-release assembly of the present invention;

FIG. 2 is an exploded view of the safe and anti-loose quick-release assembly of the present invention;

FIG. 3 is an exploded view of the lever, the pin and the rod of the safe and anti-loose quick-release assembly of the present invention;

FIG. 4 is an exploded view of the tube, the sleeve, the resilient collar, the plugs and the end part of the safe and anti-loose quick-release assembly of the present invention;

FIG. 5 is a perspective view to show the plug of the safe and anti-loose quick-release assembly of the present invention;

FIG. 6 is a cross sectional view to show the positioning unit located between the pin and the body of the lever;

FIG. 7 shows that the push piece of the positioning unit is pushed toward the pin;

FIG. 8 is a cross sectional view to show the lock status of the safe and anti-loose quick-release assembly of the present invention;

FIG. 9 shows that the safe and anti-loose quick-release assembly of the present invention is used to secure a hub, and

FIG. 10 shows a conventional the quick-release assembly.

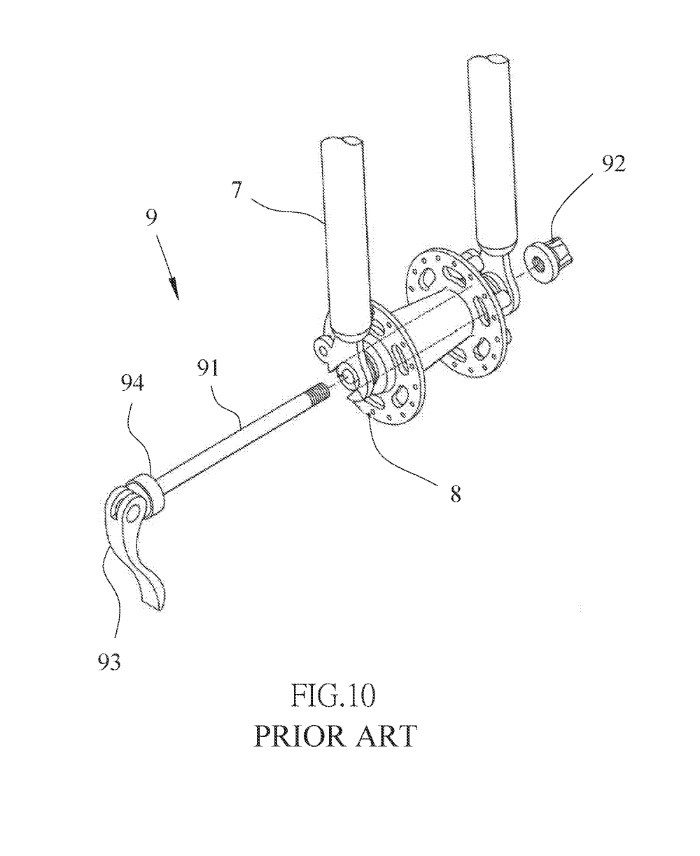

### DETAILED DESCRIPTION OF THE PREFERRED EMBODIMENT

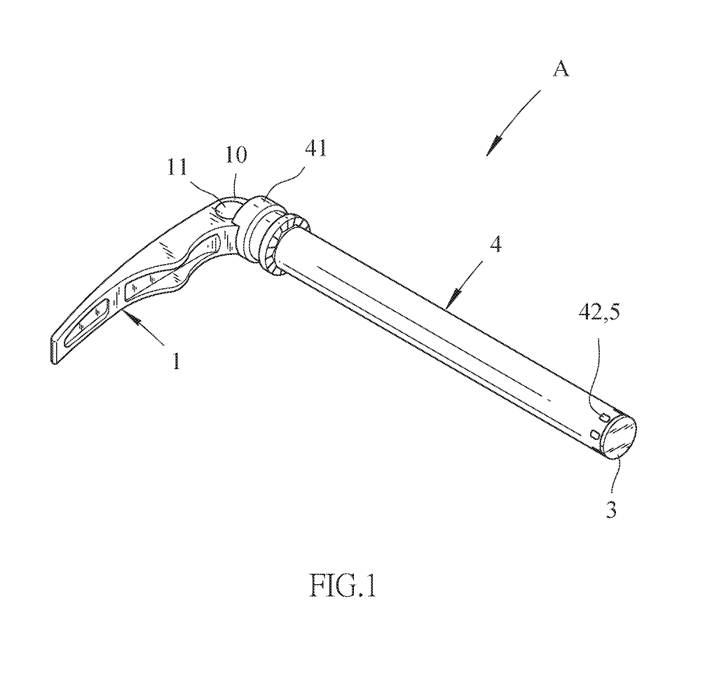

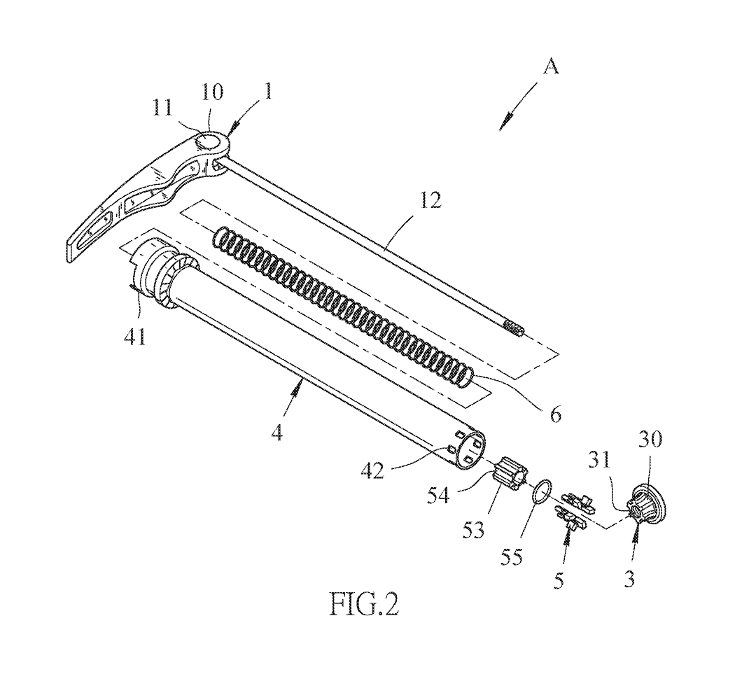

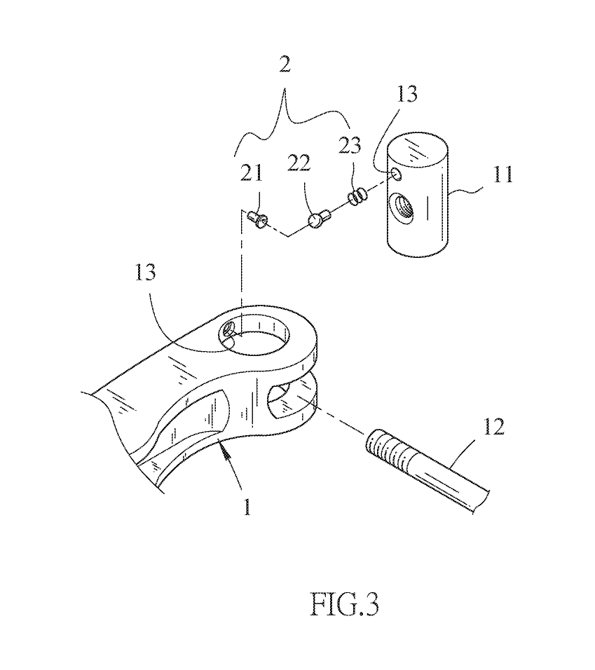

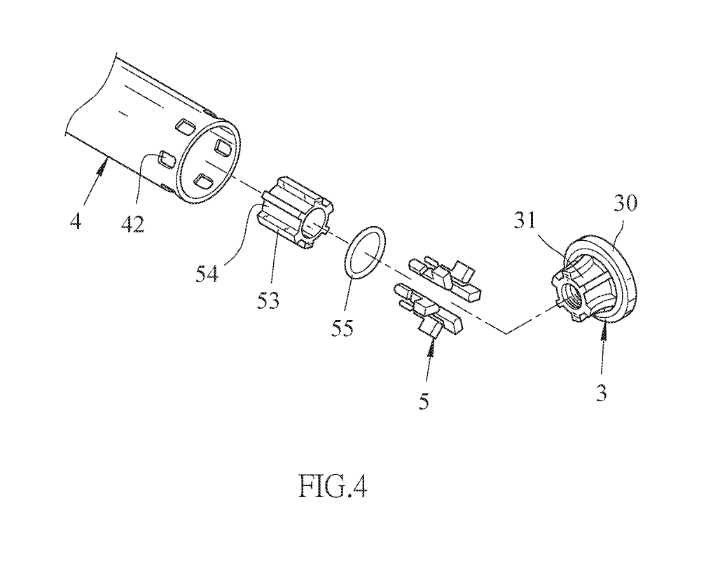

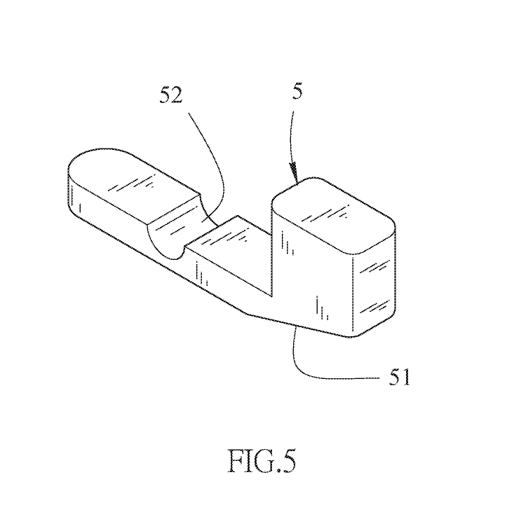

Referring to FIGS. 1 to 6, the safe and anti-loose quick-release assembly “A” of the present invention comprises a lever 1 which has a body 10, and the body 10 of the lever 1 has a cam-shaped portion. A pin 11 is located in a circular hole in the cam-shaped portion of the lever 1. A rod 12 has a first end thereof connected to the pin 11, and a threaded section is formed at the second end of the rod 12. The body 10 has a bore 13 defined through the wall thereof, and the pin 11 has a room 130 defined radially therein. The bore 13 and the room 130 are located to share a common axis.

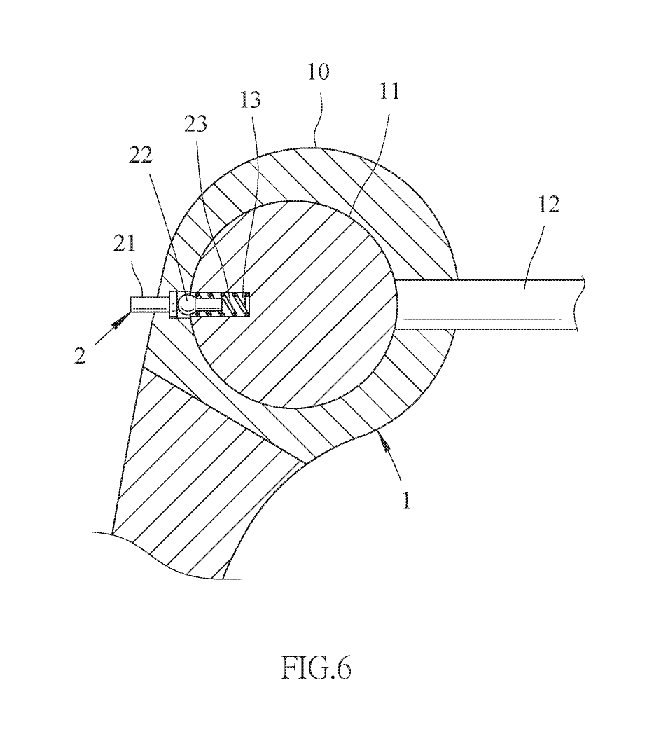

A positioning unit 2 is located in the bore 13 and the room 130. The positioning unit 2 includes a push piece 21, a biasing piece 22 and a resilient member 23. The push piece 21 has an end movably extending beyond the bore 13. The biasing piece 22 has a head and a shank, and the resilient member 23 is mounted to the shank and biased between the head and the inner end of the room 130. The push piece 21 contacts the head of the biasing piece 22 as shown in FIG. 6. When the push piece 21 protrudes beyond the bore 13, the lever 1 cannot be pivoted.

The rod 12 movably extends through a tube 4, and the tube 4 includes a seat 41 connected to the first end thereof. Multiple holes 42 are defined through the wall of the second end of the tube 4. A sleeve 53 is mounted to the rod 12 and the sleeve 53 includes multiple recesses 54 defined axially in the outer periphery thereof. A spring 6 is mounted to the rod 12 and biased between the seat 41 and the sleeve 53.

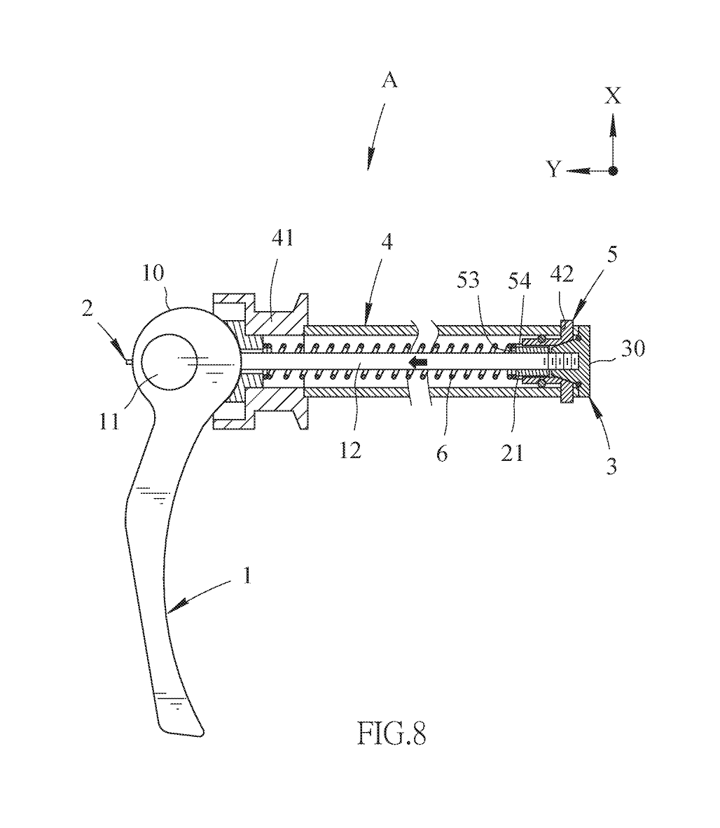

Multiple plugs 5 are mounted to the sleeve 53 and movably located in the recesses 54 as shown in FIG. 8. Each plug 5 is an L-shaped plug and has a portion movably engaged with the hole 42 corresponding thereto. Each plug 5 has an inclined face 51 defined in the underside of one end thereof. An end part 3 is threadedly connected to the second end of the rod 12 and has a cone-shaped portion 30 formed thereon. The cone-shaped portion 30 of the end part 3 is inserted into the second end of the tube 4 and engaged with the inclined face 51 of each of the plugs 5. A resilient collar 55 is mounted to the plugs 5 to restrict the plugs 5 from disengaging from the recesses 54 of the sleeve 53. The cone-shaped portion 30 of the end part 3 includes multiple grooves 31 defined axially in the outer periphery thereof. The plugs 5 are movably located in the grooves 31, when the end part 3 moves, the plugs 5 are movable along the grooves 31.

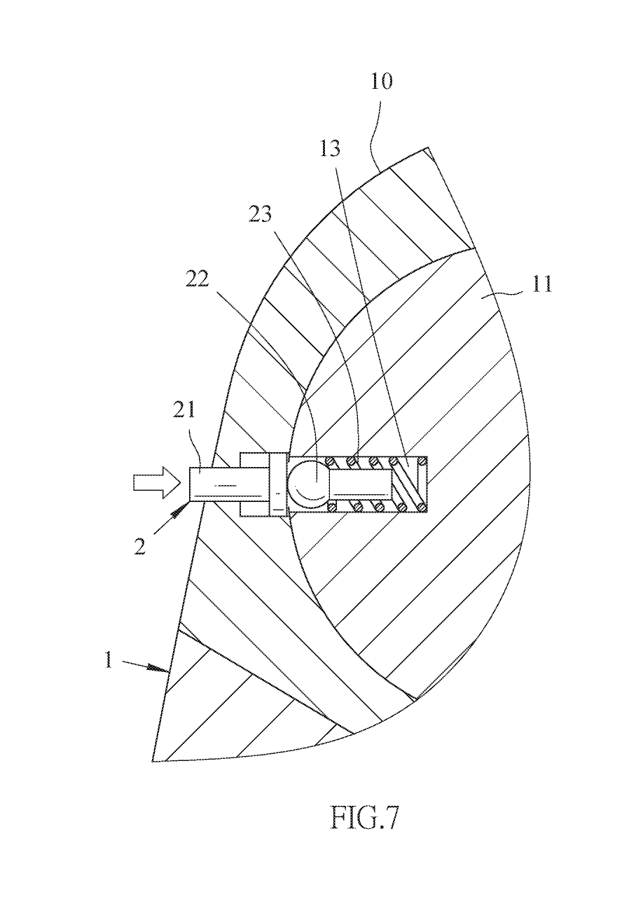

As shown in FIG. 7, when the user pushes the push piece 21 toward the pin 11 to move the biasing member 22 away from the conjunction between the circular hole of the lever 1 and the pin 11, the lever 1 is able to be pivoted.

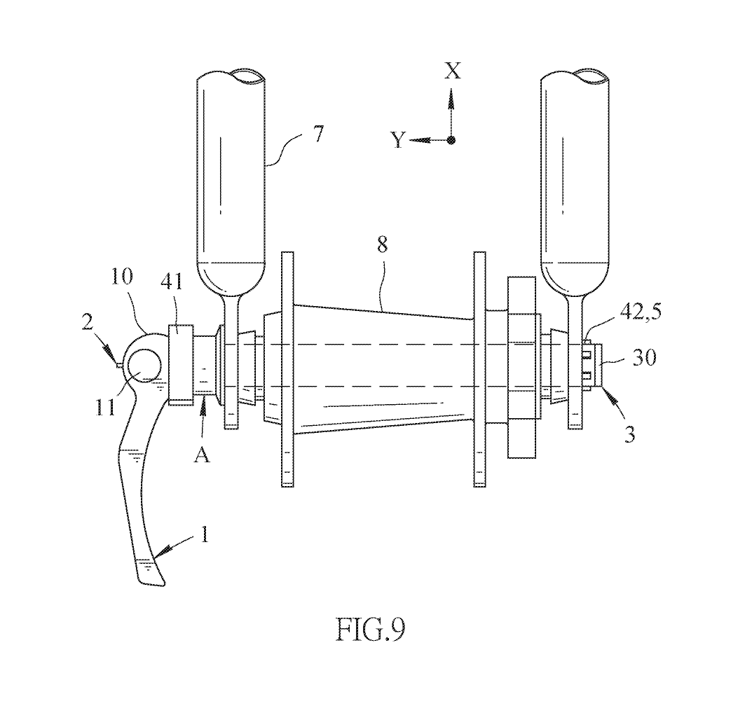

As shown in FIGS. 8 and 9, the safe and anti-loose quick-release assembly “A” of the present invention is used to secure a hub 8 of the front fork 7, and the tube 4 extends through the hub 8. When the lever 1 is pivoted such that the long axis of the cam-shape portion of the body 10 is located to be co-axially with the rod 12, the cam-shaped portion securely contacts against the seat 41 as shown in FIG. 8, the rod 12 and the cone-shaped portion 40 are moved in Y-axis direction and toward the seat 41, the inclined faces 51 of the plugs 5 move along the grooves 31 of the cone-shaped portion 30, so that the portions of the plugs 5 move in X-axis direction to protrude beyond the holes 42 respectively. The hub 8 is successfully secured to the front fork 7. The portions of the plugs 5 protruding beyond the holes 42 show that the safe and anti-loose quick-release assembly “A” is in locked status. The push piece 21 protrudes beyond the bore 13 prevents the lever 1 from being unexpectedly pivoted for providing safety to the riders.

When the user wants to release the safe and anti-loose quick-release assembly “A”, he or she simply pushes the push piece 21 inward, and then pivots the lever 1 to shift the long axis of the cam-shape portion of the body 10 from the axial direction of the rod 12, the safe and anti-loose quick-release assembly “A” is released.

While we have shown and described the embodiment in accordance with the present invention, it should be clear to those skilled in the art that further embodiments may be made without departing from the scope of the present invention.

What is claimed is:

1. A safe and anti-loose quick-release assembly comprising:
a lever having a body and a pin located in the body, the lever having a cam-shaped portion and the pin located in the cam-shaped portion of the lever, a rod having a first end thereof connected to the pin, the body having a bore defined through a wall thereof, the pin having a room defined radially therein;
a positioning unit located in the bore and the room, the positioning unit including a push piece, a biasing piece and a resilient member, the push piece having an end movably extending beyond the bore, the resilient member mounted to the biasing member and biased between the biasing member and an inner end of the room, the push piece contacting the biasing piece, when the push piece protrudes beyond the bore, the lever cannot be pivoted, and
an end part connected to a second end of the rod.

2. The safe and anti-loose quick-release assembly as claimed in claim 1, wherein the rod movably extends through a tube, the tube includes a seat connected to a first end thereof, multiple holes defined through a wall of a second end of the tube, a sleeve is mounted to the rod, multiple plugs are mounted to the sleeve and each plug has a portion movably engaged with the hole corresponding thereto, each plug has an inclined face defined in an underside of one end thereof, a cone-shaped portion is formed on the end part and inserted into the second end of the tube, the cone-shaped portion is engaged with the inclined face of each of the plugs, wherein when the lever is pivoted so that the cam-shape portion securely contacts against the seat, the rod and the cone-shaped portion are moved in Y-axis direction and toward the seat, the portions of the plugs move in X-axis direction to protrude beyond the holes respectively.

3. The safe and anti-loose quick-release assembly as claimed in claim 2, wherein a spring is mounted to the rod and biased between the seat and the sleeve.

4. The safe and anti-loose quick-release assembly as claimed in claim 2, wherein each of the plugs is an L-shaped plug.

5. The safe and anti-loose quick-release assembly as claimed in claim 2, wherein the sleeve includes multiple recesses defined axially in an outer periphery thereof, the plugs are movably located in the recesses.

6. The safe and anti-loose quick-release assembly as claimed in claim 5, wherein a resilient collar is mounted to the plugs to restrict the plugs from disengaging from the recesses of the sleeve.

7. The safe and anti-loose quick-release assembly as claimed in claim 2, wherein the cone-shaped portion of the end part includes multiple grooves defined axially in an outer periphery thereof, the plugs are movably located in the grooves, when the end part moves, the plugs are movable along the grooves.
